(19) United States
(12) Patent Application Publication
(10) Pub. No.: US 2025/0224347 A1
(43) Pub. Date: Jul. 10, 2025

(54) X-RAY ANALYSIS SYSTEM WITH FOCUSED X-RAY BEAM AND NON-X-RAY MICROSCOPE

(71) Applicant: Sigray, Inc., Concord, CA (US)

(72) Inventors: Benjamin Donald STRIPE, Berkeley, CA (US); Wenbing YUN, Walnut Creek, CA (US); Janos KIRZ, Berkeley, CA (US)

(21) Appl. No.: 19/011,219

(22) Filed: Jan. 6, 2025

Related U.S. Application Data
(60) Provisional application No. 63/618,770, filed on Jan. 8, 2024.

(51) Int. Cl. G01N 23/04; G01N 23/083

(52) U.S. Cl. CPC G01N 23/04; G01N 23/083; G01N 2223/204

(57) ABSTRACT

An apparatus includes an x-ray optic system configured to receive x-rays from an x-ray source, to focus at least some of the x-rays to form a focused x-ray beam, and to irradiate a portion of a sample with the focused x-ray beam. The focused x-ray beam has a depth-of-focus and a focused x-ray spot at the sample. The apparatus further includes a microscope having an objective configured to receive and focus light from the portion of the sample. The objective has an object plane and a field-of-view. The object plane is within a range centered on the depth-of-focus of the focused x-ray beam, the range having a width ten times the depth-of-focus, and the focused x-ray spot is within the field-of-view of the objective.

### CLAIM OF PRIORITY

This application claims the benefit of priority to U.S. Provisional Appl. No. 63/618,770 filed Jan. 8, 2024, which is incorporated in its entirety by reference herein.

### BACKGROUND

### Field

This application relates generally to x-ray analysis and/or spectroscopy systems utilizing combined x-ray and non-x-ray probes.

### Description of the Related Art

X-ray microprobes using a focused x-ray beam for excitation (e.g., micro x-ray fluorescence analysis and x-ray assisted device alteration) and probing (e.g., micro x-ray diffraction) offer powerful analysis and characterization capabilities. Often, a light microscope is used to either locate regions of interest for x-ray microprobes or complementary information (e.g., NIR, optical, Raman, etc.). Often, the x-ray microprobe and light microscope are two independent/separate systems that utilize mechanical motions to register an optical image with the focused x-ray beam, leading to potential registration errors from the mechanical motions and drift over time. It can be particularly challenging to register a small focused x-ray beam (e.g., less than 30 microns full width at half maximum (FWHM); less than 5 microns (FWHM); less than 2 microns (FWHM); less than 1 micron (FWHM)) with an optical image with positional accuracy better than 4000 nm (e.g., better than 3000 nm; better than 500 nm; within 150 nm) over an extended time without vibrational/thermal drift.

### SUMMARY

In certain implementations, an apparatus comprises an x-ray optic system configured to receive x-rays from an x-ray source, to focus at least some of the x-rays to form a focused x-ray beam, and to irradiate a portion of a sample with the focused x-ray beam. The focused x-ray beam has a depth-of-focus and a focused x-ray spot at the sample. The apparatus further comprises a microscope comprising an objective configured to receive and focus light from the portion of the sample. The objective has an object plane and a field-of-view. The object plane is within a range centered on the depth-of-focus of the focused x-ray beam, the range having a width ten times the depth-of-focus, and the focused x-ray spot is within the field-of-view of the objective.

In certain implementations, an apparatus comprises an x-ray optic system configured to receive x-rays from an x-ray source, to focus at least some of the x-rays to form a focused x-ray beam, and to irradiate a portion of a sample with the focused x-ray beam. The focused x-ray beam has a depth-of-focus and a focused x-ray spot at the sample. The apparatus further comprises a microscope objective configured to receive and focus light from the portion of the sample. The objective has an optical axis and the x-ray optic system has an x-ray propagation axis tilted relative to the optical axis. The objective has an object plane and a field-of-view. The object plane is within a range centered on the depth-of-focus of the focused x-ray beam, the range having a width ten times the depth-of-focus, and the focused x-ray spot is within the field-of-view of the objective.

In certain implementations, an apparatus comprises at least one x-ray optic configured to receive x-rays from an x-ray source, to focus at least some of the x-rays to form a focused x-ray beam, and to irradiate a portion of a sample with the focused x-ray beam. The focused x-ray beam has a depth-of-focus and a focused x-ray spot at the sample. The apparatus further comprises an objective configured to receive and focus light from the portion of the sample. The objective has an optical axis and the at least one x-ray optic has an x-ray propagation axis substantially parallel to and displaced from the optical axis. The objective has an object plane and a field-of-view. The object plane is within a range centered on the depth-of-focus of the focused x-ray beam, the range having a width ten times the depth-of-focus, and the focused x-ray spot is within the field-of-view of the objective.

### BRIEF DESCRIPTION OF THE DRAWINGS

FIG. 1 schematically illustrates an example apparatus in accordance with certain implementations described herein.

FIG. 2 schematically illustrates an example objective in accordance with certain implementations described herein.

FIG. 3 schematically illustrates an example reflective microscope comprising a mirror in accordance with certain implementations described herein.

FIG. 4 schematically illustrates an example microscope configured for darkfield correlative imaging in accordance with certain implementations described herein.

FIG. 5 schematically illustrates a portion of the optical train in accordance with certain implementations described herein.

FIG. 6 schematically illustrates another example apparatus in accordance with certain implementations described herein.

FIG. 7A schematically illustrates an example apparatus with the at least one x-ray optic tilted relative to the objective in accordance with certain implementations described herein.

FIG. 7B schematically illustrates a top view of the focused x-ray beam and the reflected light at the sample corresponding to FIG. 7A in accordance with certain implementations described herein.

### DETAILED DESCRIPTION

Certain implementations described herein provide an apparatus comprising a correlative microscope (e.g., non-x-ray; visible light; infrared light; near-infrared light) microscope and an x-ray focusing system in which the field-of-view of the correlative microscope is concurrently co-localized (e.g., at least partially overlapped) with the focused x-ray beam of the x-ray focusing system. Previously, such co-localization has not been possible because of the limited working distance of conventional x-ray focusing systems (e.g., polycapillary lenses) and due to the size of the objective of the microscope and geometry of the polycapillary lens, which can have both a relatively large outer diameter combined with a short working distance to achieve a small focus (e.g., in a range of 2 mm to 3 mm).

In certain implementations, the apparatus comprises an on-axis x-ray illumination detection/measurement system, a brightfield/darkfield optical microscopy alignment system, an x-ray assisted device alteration (XADA) system, and/or an x-ray fluorescence (XRF) system. In certain implementations, the apparatus additionally comprises means (e.g., stage; motor) for aligning the object plane of an objective of the correlative microscope within the depth-of-focus of the focused x-ray beam (e.g., for ensuring that the focused x-ray spot is within the field-of-view of the correlative microscope). In certain implementations, the correlative microscope includes at least a brightfield visible light microscope, a darkfield visible light microscope, a near-infrared (NIR) microscope, an infrared microscope, or a combination of these approaches.

In certain implementations, an apparatus comprises a microscope configured to receive light (e.g., visible light; infrared light; near-infrared light) propagating along an optical axis and an x-ray focusing system configured to emit a focused x-ray beam along an x-ray propagation axis. The apparatus is configured for simultaneous co-localization of the field-of-view of the microscope and the focused x-ray beam. For example, the object plane of the microscope can be within the depth-of-focus of the focused x-ray beam and the focused x-ray beam can be within the field-of-view of the microscope. In certain implementations, the x-ray propagation axis is substantially colinear (e.g., an angle substantially equal to zero degrees) or has a small angle with respect to at least a portion of the optical axis (e.g., an angle less than 30 degrees; less than 10 degrees; less than 3 degrees). For example, the focused x-ray beam and the optical axis can be substantially colinear or on-axis with one another.

In certain implementations, the apparatus comprises a mirror (e.g., in the light beam path) configured to reflect light away from the x-ray propagation axis (e.g., by more than 30 degrees; by more than 60 degrees; by more than 90 degrees). In certain implementations, the mirror is configured to allow the focused x-ray beam to propagate through the mirror (e.g., with a transmission efficiency greater than 70%; transmission efficiency greater than 25%; transmission efficiency greater than 10%). For example, a portion of the mirror can comprise a hole or a thin solid material positioned on the x-ray propagation axis and through which the focused x-ray beam propagates.

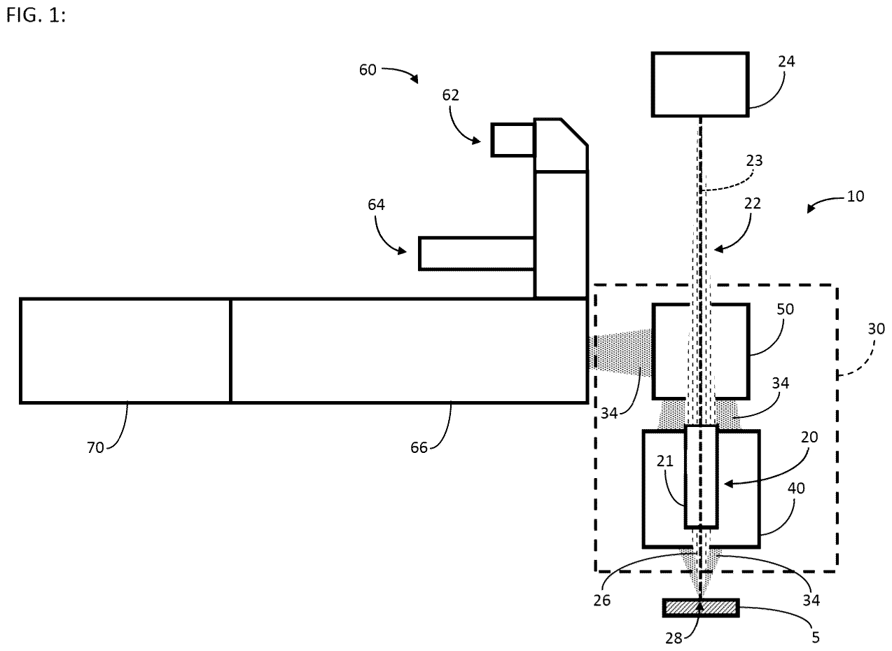

FIG. 1 schematically illustrates an example apparatus 10 in accordance with certain implementations described herein. In certain implementations, the apparatus 10 comprises a multi-modal illumination apparatus. As shown in FIG. 1, the apparatus 10 comprises an x-ray optic system 20 configured to receive x-rays 22 from an x-ray source 24, to focus at least some of the x-rays 22 to form a focused x-ray beam 26, and to irradiate a portion of a sample 5 with the focused x-ray beam 26. The focused x-ray beam 26 has a depth-of-focus and a focused x-ray spot 28 at the sample 5. The apparatus 10 further comprises a microscope 30 comprising an objective 40 configured to receive and focus light 34 (e.g., visible, infrared, and/or near-infrared light) from the portion of the sample 5. At least a portion of the x-ray optic system 20 is located within the objective 40. The objective 40 has an object plane and a field-of-view, the object plane within in a range centered on the depth-of-focus of the focused x-ray beam 26, the range having a width ten times the depth-of-focus, and the focused x-ray spot 28 within the field-of-view of the objective 40.

In certain implementations, the x-ray optic system 20 and the microscope 30 are rigidly attached to one another (e.g., after the x-ray optic system 20 and the microscope 30 have been aligned with one another) to ensure stable positioning. In certain implementations, the x-ray optic system 20 is rigidly attached to the objective 40. For example, the x-ray optic system 20 and the microscope 30 can be affixed to one another by an adjustable alignment mechanism (e.g., one or more re-centering screws; a stage with focus adjustment and an x/y stage to move the x-ray optic system 20 relative to the sample 5 so as to locate the region of interest). The alignment mechanism can be adjusted to compensate for alignment deviations that are due to temperature changes (e.g., from changes in the light intensity or brightness) and to maintain the alignment (e.g., to micron or sub-micron resolutions).

In certain implementations, the x-ray optic system 20 is configured to receive at least some of the x-rays 22 propagating along an x-ray propagation axis 23 from the x-ray source 24 and to direct the focused x-ray beam 26 to propagate along the x-ray propagation axis 23 to the sample 5. The x-ray optic system 20 can comprise at least one hollow capillary x-ray optic 21 (e.g., tube) with an inner surface that reflects at least some of the x-rays 22 through total external reflection (TER). For example, the inner surface can comprise glass, either uncoated or coated with at least one high atomic mass density material (e.g., Cr, W, Mo, Pt, Ir) or with a multilayer coating (e.g., comprising periodic layers of alternating high atomic mass density and low atomic mass density materials, such as Cr/C, W/C, Mo/Si). In certain implementations, the inner surface profile (e.g., in a plane comprising or parallel to a longitudinal axis of the x-ray optic 21 and/or the x-ray propagation axis 23) comprises at least one segment of a quadric shape (e.g., ellipsoid; hyperboloid; paraboloid). For example, the inner surface profile can have an ellipsoid shape, and the at least one x-ray optic 21 can be positioned such that the x-ray source 24 is located at a first focus of the ellipsoid while the focused x-ray spot 28 (e.g., at the region of interest of the sample 5) is positioned at a second focus of the ellipsoid. The inner surface profile can be shaped to reflect x-rays 22 at a cut-off angle in a predetermined range (e.g., 5 keV to 10 keV; less than 1 keV; 1 keV to 5 keV; 5 keV to 6 keV; 5 keV to 8 keV; less than 10 keV; less than 30 keV). In certain implementations, the at least one x-ray optic 21 is integral with (e.g., attached to) the objective 40 (e.g., at least partially within the objective 40), while in certain other implementations, the at least one x-ray optic 21 has a sufficiently long working distance and the objective 40 has a sufficiently small length that the objective 40 is positioned between the at least one x-ray optic 21 and the sample 5 (e.g., at least one x-ray optic 21 is positioned “behind” the objective 40 on the x-ray propagation axis 23). In certain implementations, the at least one x-ray optic 21 has a working distance in a range of greater than 10 mm (e.g., greater than 20 mm; greater than 30 mm; greater than 40 mm) and is co-registered with the optical axis 41 of the objective 40 such that the light 34 received by the objective 40 is from the same spot of the sample 5 as is irradiated by the focused x-ray beam 26 (e.g., the focused x-ray spot 28).

In certain implementations, the at least one x-ray optic 21 comprises first and second reflective (e.g., mirrored) paraboloidal segments (e.g., a “double paraboloid” configuration), such that the first paraboloid segment collimates at least some of the x-rays 22 diverging from the x-ray source 24 (e.g., placed at a virtual focal point of the first paraboloid segment) and the second paraboloid segment receives and focuses the collimated x-rays to a spot (e.g., point) at the object plane of the objective 40 (e.g., at or on the sample 5). This double paraboloid configuration can be achieved by an x-ray optic system 20 comprising a single x-ray optic 21 (e.g., single tube) or a plurality (e.g., two) of x-ray optics 21 (e.g., two tubes) with their longitudinal axes aligned with one another.

Other examples of the at least one x-ray optic 21 include but are not limited to: double paraboloid segments and Wolter optics (e.g., comprising hyperboloid, paraboloid, and/or paraboloid/ellipsoid segments). For example, the at least one x-ray optic 21 can include a first reflective (e.g., mirrored) hyperboloid configured to collect at least some of the x-rays 22 diverging from the x-ray source 24 (e.g., placed at a virtual focal point of the first reflective hyperboloid and a second reflective (e.g., mirrored) ellipsoid configured to collect and focus some of the x-rays collected by the hyperboloid to a spot at the object plane of the objective 40 (e.g., at or on the sample 5). In another example, the order of the hyperboloid and ellipsoid is reversed. For another example, the at least one x-ray optic 21 can include a first reflective (e.g., mirrored) hyperboloid/paraboloid pair configured to collimate at least some of the x-rays 22 diverging from the x-ray source 24 (e.g., placed at a virtual focal point of the first mirrored hyperboloid/paraboloid pair) and a second reflective (e.g., mirrored) hyperboloid/paraboloid pair configured to focus the collimated x-rays 22 to a spot at the object plane of the objective 40 (e.g., at or on the sample 5). In certain implementations, the x-ray optic system 20 comprises at least one central beam stop (not shown) comprising a high atomic mass density material (e.g., tungsten) configured to attenuate (e.g., block; prevent) non-reflected x-rays from propagating from the x-ray source 24 to the sample 5.

As used herein, the phrase “depth-of-focus” refers to a region, centered on the position at which the focused x-ray beam 22 has its minimum cross-sectional area (e.g., the focal point of the at least one x-ray optic 21) and extending a distance along the x-ray propagation axis 23, in which the focused x-ray beam 22 has a cross-sectional area that is less than or equal to 1.5× its minimum cross-sectional area. In certain implementations, the distance that the depth-of-focus extends along the x-ray propagation axis 23 is in a range of 1 micron to 500 microns (e.g., less than 300 microns; less than 200 microns; less than 100 microns).

In certain implementations, the object plane is within a range centered on the depth-of-focus of the focused x-ray beam 22, the range having a width ten times the depth-of-focus (e.g., the range extends a distance along the x-ray propagation axis 23 that is ten times the depth-of-focus). In certain implementations, the object plane is within a range centered on the depth-of-focus of the focused x-ray beam 22, the range having a width five times the depth-of-focus (e.g., the range extends a distance along the x-ray propagation axis 23 that is five times the depth-of-focus). In certain implementations, the object plane is within the depth-of-focus of the focused x-ray beam 22.

In certain implementations, the x-ray optic system 20 can include one or more of the following:
Magnification, such that the size (e.g., width; diameter) of the focused x-ray spot 28 at or on the sample 5 is larger than the size of the spot of the x-ray source 24 at which the x-rays 22 are generated. For example, the magnification can be greater than 1:10, (e.g., 1:7, 1:5, 1:3, 1:2) and can be enabled by the quadric surface profile of the inner surface of the x-ray optic system 20.
1:1 magnification, such that the size (e.g., width; diameter) of the focused x-ray spot 28 at or on the sample 5 is equal to the size of the spot of the x-ray source 24 at which the x-rays 22 are generated.
Demagnification, such that the size (e.g., width; diameter) of the focused x-ray spot 28 at or on the sample 5 is smaller than the size of the spot of the x-ray source 24 at which the x-rays 22 are generated. For example, the demagnification can be less than 10:1 (e.g., 7:1, 6:1, 5:1, 4:1, 3:1, 2:1) and can be enabled by the quadric surface profile of the inner surface of the x-ray optic system 20.
Maximum inner width (e.g., diameter) of the profile of the inner surface of the at least one x-ray optic 21 can be in a range of less than 10 mm (e.g., less than 6 mm; less than 4 mm; 1 mm to 4 mm; 1 mm to 2 mm; 1 mm to 3 mm).
Nominal exterior width (e.g., diameter) of the at least one x-ray optic 21 can be in a range of 2 mm to 20 mm (e.g., 2 mm to 12 mm; 3 mm to 5 mm; 4 mm).
Entrance/exit widths (e.g., diameters) of the at least one x-ray optic 21 can be in a range of less than 4 mm (e.g., less than 2 mm; less than or equal to 1 mm).
Length of at least one x-ray optic 21 can be in a range of 5 mm to 100 mm (e.g., 5 mm to 10 mm; 10 mm to 20 mm; 20 mm to 50 mm; 20 mm to 100 mm).
Distance between the x-ray source 24 and the sample 5 can be in a range of 50 mm to 500 mm (e.g., 50 mm to 100 mm; 100 mm to 300 mm; 150 mm to 250 mm; 100 mm to 500 mm).
Point spread function of the x-ray optic system 20 can be in a range of less than 15 microns (e.g., less than 10 microns; less than 5 microns; less than 2 microns; less than 1 micron; less than 0.7 micron; less than 0.5 micron; less than 0.3 micron; less than 0.2 micron).
Spot size (e.g., width; diameter) of the focused x-ray spot 28 at (e.g., on) the sample 5 can be in a range of less than 25 microns (e.g., less than 15 microns; less than 10 microns; less than 5 microns; less than 3 microns; less than 2 microns; less than 1 micron; less than 0.5 micron; less than 0.3 micron).
The at least one x-ray optic 21 can comprise a central stop (e.g., cap) configured to attenuate (e.g., block) non-reflected x-rays from propagating through the at least one x-ray optic 21 to the sample 5.

In certain implementations, the apparatus 10 further comprises the x-ray source 24 (e.g., a microfocus x-ray source). The x-ray source 24 can comprise an electron beam source configured to generate an electron beam and at least one x-ray target comprising at least one x-ray generating material (e.g., SiC, Co, Cu, Cr, W, Mo, Rh, and Au) configured to generate and emit x-rays 22 in response to bombardment by at least a portion of the electron beam onto the at least one x-ray target. The generated x-rays 22 can have energies of a characteristic x-ray line of the at least one x-ray generating material which can be in a range of less than 25 keV (e.g., 4 keV to 8 keV; 5 keV to 9 keV; 5 keV to 11 keV). The at least one x-ray target can be in thermal contact with a diamond substrate (e.g., in thermal communication with a thermally conductive holder) for improved heat dissipation. For example, at least one x-ray target can include but is not limited to a metal target (e.g., SiC, Co, Cu, Cr, W, Mo, Rh, and Au) comprising discrete microstructures or a target that is a thin film on a diamond substrate in thermal communication with a copper holder.

In certain implementations, the x-ray source 24 can further include one or more of the following:
A plurality of x-ray targets and the x-ray source 24 configured to be switched between different x-ray targets to generate different x-ray spectra (e.g., with energies of different characteristic x-ray lines).
A reflection geometry and a beryllium window with a thickness less than 500 microns (e.g., less than 250 microns; less than 125 microns; less than 50 microns; less than 25 microns).
Spot size (e.g., width; diameter) at which the x-rays 22 are generated is in a range of 0.3 micron to 25 microns (FWHM) (e.g., 0.3 micron to 10 microns; 0.3 micron to 7 microns; 1 micron to 5 microns; 2 microns to 8 microns; 1 micron to 15 microns).

In certain implementations, the microscope 30 comprises a visible light microscope, an infrared light microscope, and/or a near-infrared (NIR) light microscope. For example, the microscope 30 can be configured to be operated in a brightfield illumination mode and/or a darkfield illumination mode.

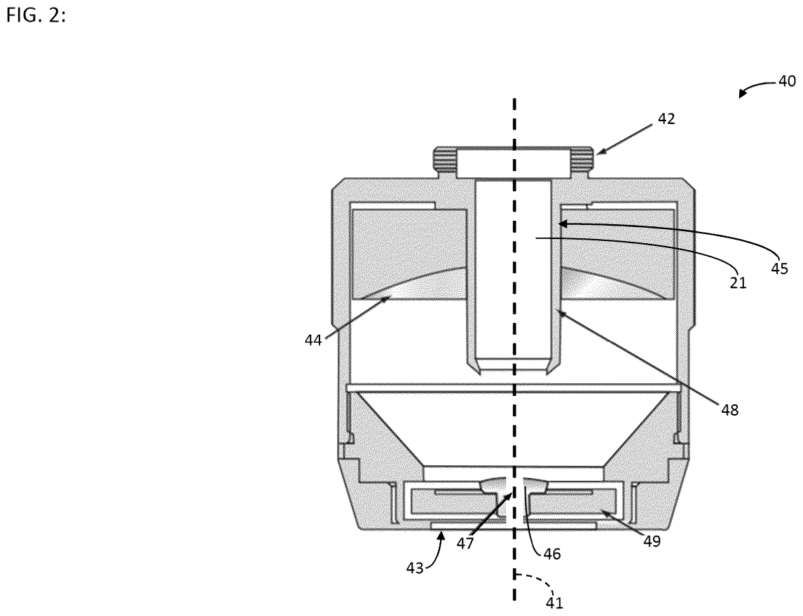

FIG. 2 schematically illustrates an example objective 40 (e.g., light objective; optical objective) in accordance with certain implementations described herein. The objective 40 comprises an x-ray transmissive region extending completely through the objective 40 (e.g., along an optical axis 41 of the objective 40). The objective 40 can be fabricated by modifying a commercially available visible objective (e.g., from Nikon, Olympus, Zeiss, Edmund, etc.). For example, as shown in FIG. 2, the objective 40 comprises a reflective microscope objective comprising a first port 42, a second port 43, a first (e.g., primary) mirror 44, a second (e.g., secondary) mirror 46, and a stray light baffle 48. The first mirror 44 and the second mirror 46 can be aspherical or can be substantially spherical (e.g., based on the Schwarzschild design; with deviations configured to reduce aberrations).

In certain implementations, the first mirror 44 and/or the second mirror 46 can comprise an aperture (e.g., hole) or an x-ray transmissive region configured to allow at least some of the x-rays 22 (e.g., the focused x-ray beam 26) to propagate therethrough (e.g., having an x-ray transmission efficiency greater than 70%; transmission efficiency greater than 25%; transmission efficiency greater than 10%). For example, as shown in FIG. 2, the first mirror 44 comprises a first aperture 45 in a central region of the first mirror 44 and extending through the first mirror 44 (e.g., along the optical axis 41; along the x-ray propagation axis 23) with the stray light baffle 48 extending through the first aperture 45 and the second mirror 46 comprises a second aperture 47 in a central region of the second mirror 46 and extending through the second mirror 46 (e.g., along the optical axis 41; along the x-ray propagation axis 23). The first aperture 45 and the second aperture 47 can be formed by drilling or cutting the first mirror 44 or the second mirror 46, respectively. The first mirror 44 and/or the second mirror 46 can be in mechanical communication with a mount 49 (e.g., spider mount). The first and second apertures 45,47 have a size (e.g., width; diameter) that is greater than the size (e.g., width; diameter) of the beam of x-rays 22 received from the x-ray source 24.

In certain implementations, at least a portion of the at least one x-ray optic 21 is positioned within the first aperture 45 and within the stray light baffle 48. The at least one x-ray optic 21 is configured to receive the x-rays 22 (e.g., via the first port 42) and to focus at least some of the x-rays 22 (e.g., through the first mirror 44) to form the focused x-ray beam 26 and to direct the focused x-ray beam 26 (e.g., through the second mirror 46) to the sample 5 (e.g., via the second port 43). The first mirror 44 is configured to receive reflected light 34 from the sample 5 (e.g., via the second port 43) and to reflect the light 34 to the second mirror 46. The second mirror 46 is configured to reflect the light 34 to other components of the microscope 30 (e.g., through the first aperture 45 and the first port 42).

In certain implementations, the objective 40 can further include one or more of the following:
Magnification in a range of 4× to 60× (e.g., 4×; 10×; 20×; 30×; 40×; 50×; 60×).
Clear aperture having a width (e.g., diameter) in a range of 1 mm to 8 mm (e.g., 5.1 mm).
Field-of-view having a width (e.g., diameter) in a range of 50 microns to 4000 microns.
Sufficiently wide first aperture 45 or an x-ray transmissive region central region such that the at least one x-ray optic 21 is non-concentric (e.g., not centered) with the optical axis 41. In certain such implementations, x-rays 22 and/or the focused x-ray beam 26 propagating along most of the optical path 41 are unobstructed, and a longitudinal axis of the at least one x-ray optic 21 can be tilted by an angle less than 10 degrees (e.g., in a range of 5 degrees to 10 degrees (as non-limiting examples) from the optical axis 41.

In certain other implementations, the objective 40 comprises a refractive microscope objective comprising at least one lens. The at least one lens can have an aperture (e.g., hole) configured to receive the at least one x-ray optic 21 and to allow at least some of the x-rays 22 to propagate therethrough (e.g., having an x-ray transmission efficiency greater than 70%; transmission efficiency greater than 25%; transmission efficiency greater than 10%).

In certain implementations, as shown in FIG. 1, the apparatus 10 further comprises a mirror 50, at least one light source 60 (e.g., light-emitting diode; fiber optics) and at least one light detector 70 (e.g., camera; Goldeye short-wave infrared camera available from Allied Cision of Stadtroda, Germany). As shown in FIG. 1, the at least one light source 60 can comprise a darkfield light port 62, a brightfield light port 64, and an optical train 66 configured to provide optical communication between the microscope 30 and the darkfield light port 62, the brightfield light port 64, and the at least one light detector 70. The at least one light source 60 can be configured to illuminate the portion of the sample 5 with light 69 (e.g., visible light; infrared light; near-infrared light) and the objective 40 can be configured to receive a reflected portion of the light 34 from the portion of the sample 5 and to direct the reflected portion of the light 34 to the optical train 66 which provides the light 34 to the at least one light detector 70. Examples of optical trains 66 compatible with certain implementations described herein include but are not limited to the WIDE video microscope unit (VMU) series available from Mitutoyo of Takatsu-ku, Kawasaki, Kanagawa Japan. In certain implementations, the optical train 66 can be considered to further comprise the objective 40. While certain implementations illuminate the portion of the sample 5 with light propagating through the optical train 66 and through the objective 40, in certain other implementations, ring lighting or fiber optic lighting separate from the objective 40 can be used.

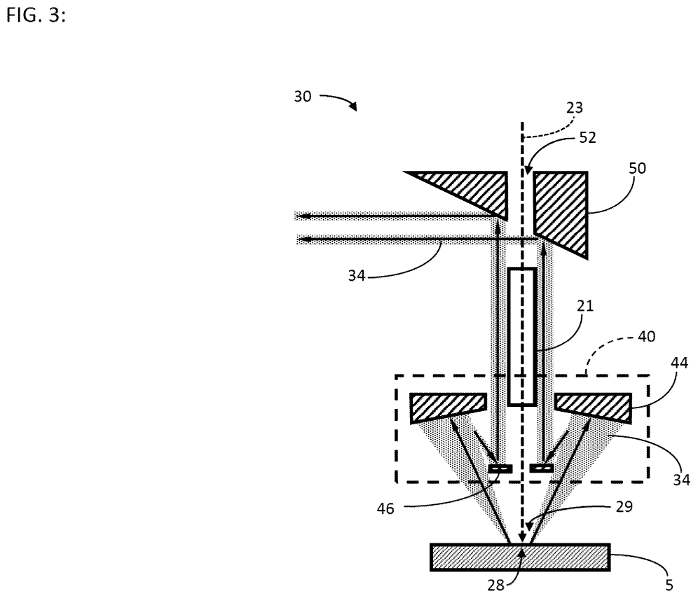

In certain implementations, the mirror 50 is configured to receive and reflect the light 34 from the portion of the sample 5, the light 34 propagating substantially collinearly with the focused x-ray beam 26 (e.g., along the x-ray propagation axis 23). The mirror 50 is positioned along both the optical axis 41 of the objective 40 and the x-ray propagation axis 23 and is configured to receive the light 34 from the objective 40 and to reflect the light 34 away from the x-ray propagation axis 23 beam (e.g., by more than 30 degrees, more than 60 degrees, or more than 90 degrees) towards the at least one light detector 70. For example, the mirror 50 can be positioned such that the reflective surface is 45 degrees relative to the x-ray propagation axis 23 such that the light 34 is deflected by 90 degrees. FIG. 3 schematically illustrates an example microscope 30 comprising a mirror 50 in accordance with certain implementations described herein. The mirror 50 comprises an aperture 52 (e.g., hole) or an x-ray transmissive region extending along the x-ray propagation axis 23 completely through the mirror 50 and configured to allow at least some of the x-rays 22 to propagate therethrough (e.g., having an x-ray transmission efficiency greater than 70%; transmission efficiency greater than 25%; transmission efficiency greater than 10%). In certain other implementations, the mirror 50 comprises a sufficiently small thickness and a material that is sufficiently transmissive to the x-rays 22 to allow more than 10% (e.g., more than 25%; more than 70%) of the x-rays 22 to propagate through the mirror 50. FIG. 3 also shows a region 29 that overlaps and/or is adjacent to the focused x-ray spot 28 from which the light 34 reflected from the sample 5 is occluded (e.g., by the second mirror 46 or other components of the objective 40) from reaching the first mirror 44 (e.g., such that the light 34 reflected from this occluded region 29 is not directed by the objective 40 and the mirror 50 to the at least one light detector 70).

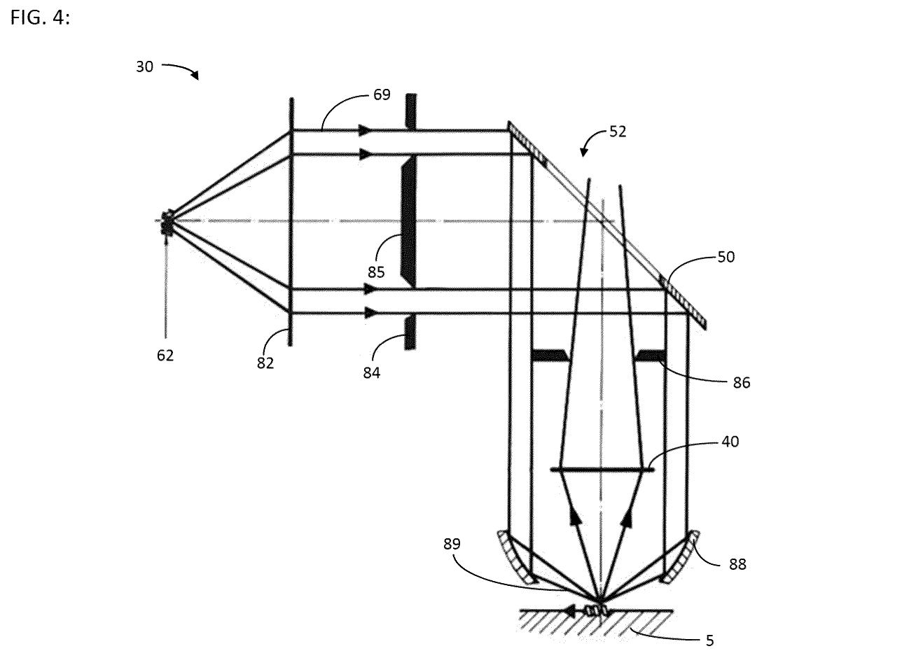

While FIG. 3 shows the reflected light 34 being directed by the objective 40 and the mirror 50 towards the at least one light detector 70, in certain implementations, the objective 40 and the mirror 50 also direct incident light from the at least one light source 60 to the sample 5. FIG. 4 schematically illustrates an example microscope 30 configured for darkfield correlative (e.g., non-x-ray) imaging in accordance with certain implementations described herein. The microscope 30 comprises the darkfield illumination port 62 of the at least one light source 60 (e.g., configured to receive light 69 from a ring illuminator or a fiber optic illuminator), a light collector 82, a condenser-aperture diaphragm 84 with a central stop 85, the mirror 50 with a central aperture 52, an objective-aperture diaphragm 86, the objective 40 (indicated in FIG. 4 by a principal plane), and a condenser 88 (e.g., ring condenser). The microscope 30 of FIG. 4 can be configured to produce an annular (e.g., ring-shaped) light beam 89 (e.g., focused by the condenser 88) and to irradiate the sample 5 with the annular light beam 89. The darkfield information can travel through the center of the aperture 52 to be detected.

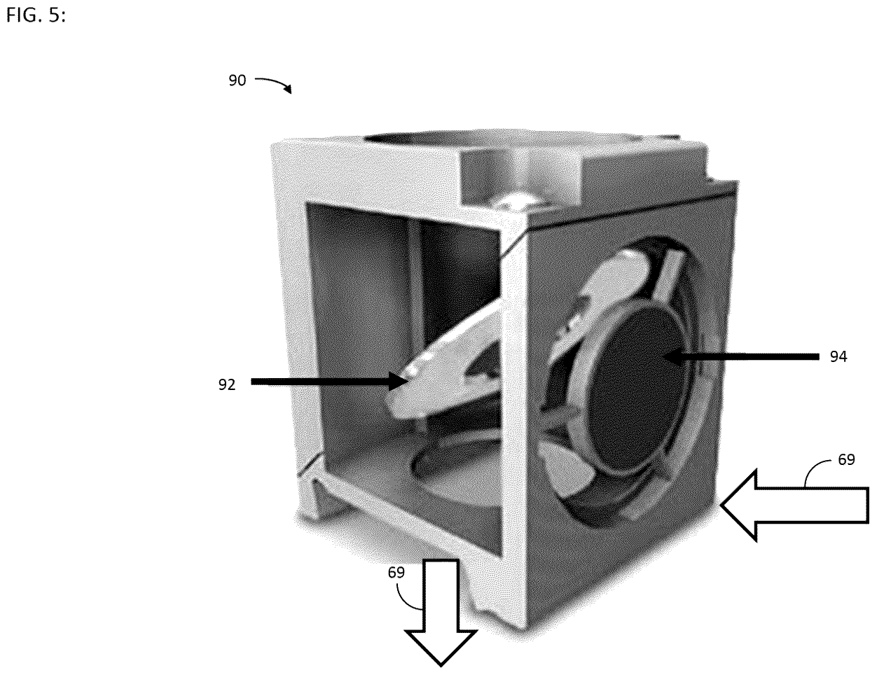

FIG. 5 schematically illustrates a portion of the optical train 66 (e.g., VMU) in accordance with certain implementations described herein. The optical train 66 comprises a reflected light darkfield mirror block 90 (e.g., right-angle mirror) compatible for performing darkfield correlative (e.g., non-x-ray) microscopy. The mirror block 90 comprises an elliptical front surface mirror 92 and a spider light stop 94. Light 69 from the at least one light source 60 (e.g., the darkfield illumination port 62) is received by the mirror block 90 and is directed through the objective 40 to the sample 5.

In certain implementations, the apparatus 10 is configured to be used for navigating and probing a sample 5 comprising a semiconductor device under testing. In certain implementations, the microscope 30 is used for navigation around the sample 5 and the x-ray optic system 20 is used for circuit design debugging and/or for determining the location of marginal failures. In certain implementations in which the sample 5 comprises a semiconductor wafer, the focused x-ray beam 26 and the non-x-ray light 69 impinge the same side of the sample 5 as one another, while in certain other implementations, the focused x-ray beam 26 and the non-x-ray light 69 impinge different sides of the sample 5 from one another. In certain implementations, the focal point of the focused x-ray beam 26 can be aligned with the light 69 impinging on the sample 5, and the microscope 30 can be retracted to provide room for a large solid-angle x-ray detector. In certain implementations, the x-ray optic system 20 comprises recesses (e.g., grooves) on the side of the at least one x-ray optic 21 to allow closer placement of at least one solid-state detector (SSD).

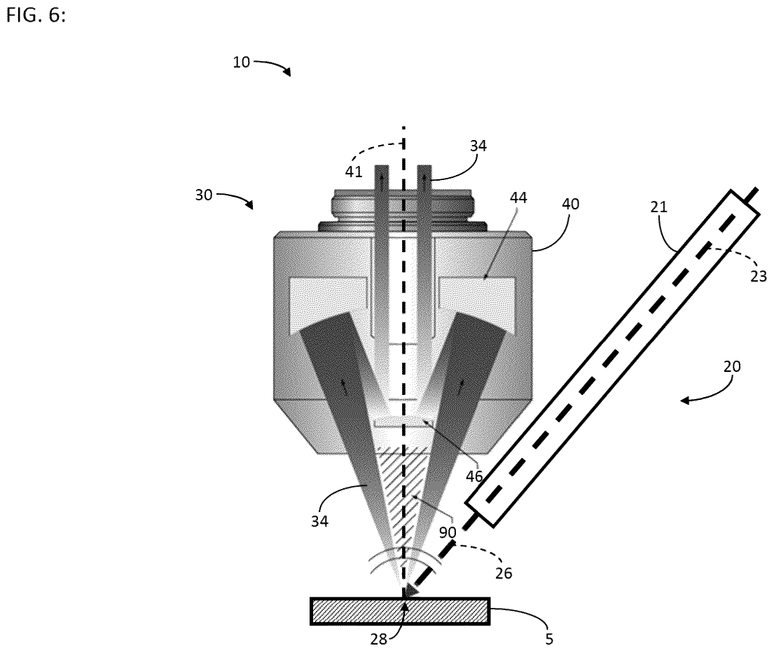

FIG. 6 schematically illustrates another example apparatus 10 in accordance with certain implementations described herein. The apparatus 10 comprises an x-ray optic system 20 comprising at least one x-ray optic 21 and a microscope 30 comprising an objective 40. The at least one x-ray optic 21 and the objective 40 are aligned to the same location at the sample 5. The at least one x-ray optic 21 can comprise a capillary tube with at least a portion of its inner reflecting surface profile having a shape of least one segment of a quadric shape such as an ellipsoid, hyperboloid, paraboloid, spheroid, as described herein. As shown in FIG. 6, the at least one x-ray optic 21 and the objective 40 are co-registered with one another (e.g., light 34 received by the objective 40 is from the same spot of the sample 5 as is irradiated by the focused x-ray beam 26) but are not axially aligned with one another (e.g., the x-ray propagation axis 23 of the at least one x-ray optic 21 is not co-linear with the optical axis 41 of the objective 40). For example, the objective 40 can have a recess (e.g., groove; channel) and the at least one x-ray optic 21 can be positioned into the recess. In certain such implementations, the objective 40 and the at least one x-ray optic 21 are integral (e.g., monolithic) with one another, while in certain other implementations, the at least one x-ray optic 21 is spaced from the objective 40. The angle between the x-ray propagation axis 23 and the optical axis 41 can be in a range of 30 degrees to 60 degrees (e.g., 45 degrees).

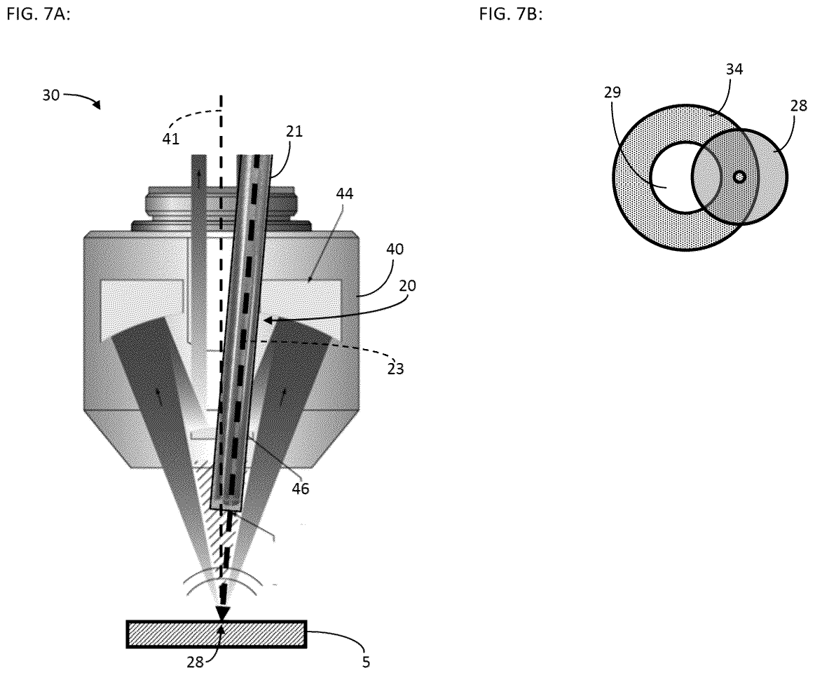

FIG. 6 also shows the occluded portion 90 of the reflected light 34 from the region 29 of the sample 5, which can exist in certain implementations in which the at least one x-ray optic 21 is at least partially within the objective 40 (see, e.g., FIGS. 1-3) and in certain implementations in which the at least one x-ray optic 21 is outside the objective 40 (see, e.g., FIG. 6). In certain implementations, the at least one x-ray optic 21 can be tilted relative to the objective 40 (e.g., the x-ray propagation axis 23 can have a non-zero angle relative to the optical axis 41). In certain other implementations, the at least one x-ray optic 21 can be substantially parallel to and displaced from the optical axis 41 (e.g., the at least one x-ray optic 21 displaced from a center axis of the objective 40). FIG. 7A schematically illustrates an example apparatus 10 with the at least one x-ray optic 21 tilted relative to the objective 40 in accordance with certain implementations described herein. The non-zero angle between the x-ray propagation axis 23 and the optical axis 41 can be in a range of less than 45 degrees (e.g., in a range of 5 degrees to 10 degrees) or less than 5 degrees. FIG. 7B schematically illustrates a top view of the focused x-ray beam 28 and the reflected light 34 at the sample 5 corresponding to FIG. 7A in accordance with certain implementations described herein. FIG. 7B shows the focused x-ray spot 28 overlapping the region illuminated by the incident light 69 from which the reflected light 34 is received by the objective 40 (e.g., the objective 40 not receiving reflected light 34 from the occluded region 29). While the lighting contrast can be reduced by the at least one x-ray optic 21 occluding some of the reflected light 34, the size (e.g., width; diameter) of the focused x-ray spot 28 can be negligibly affected by having the at least one x-ray optic 21 non-perpendicular to the surface of the sample 5.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

What is claimed is:

1. An apparatus comprising:
an x-ray optic system configured to receive x-rays from an x-ray source, to focus at least some of the x-rays to form a focused x-ray beam, and to irradiate a portion of a sample with the focused x-ray beam, the focused x-ray beam having a depth-of-focus and a focused x-ray spot at the sample; and
a microscope comprising an objective configured to receive and focus light from the portion of the sample, the objective having an object plane and a field-of-view, the object plane within a range centered on the depth-of-focus of the focused x-ray beam, the range having a width ten times the depth-of-focus, and the focused x-ray spot within the field-of-view of the objective.

2. The apparatus of claim 1, wherein at least a portion of the x-ray optic system is located within the objective.

3. The apparatus of claim 1, further comprising a light source configured to illuminate the portion of the sample with incident light, the objective configured to receive a reflected portion of the incident light from the portion of the sample.

4. The apparatus of claim 3, wherein the light source comprises both brightfield and darkfield illumination.

5. The apparatus of claim 4, wherein the darkfield illumination comprises a ring illuminator or a fiber optic illuminator.

6. The apparatus of claim 1, further comprising the x-ray source, the x-ray source comprising:
an electron beam source configured to generate an electron beam; and
at least one target comprising at least one x-ray generating material, the at least one x-ray generating material configured to generate and emit x-rays in response to bombardment by at least a portion of the electron beam.

7. The apparatus of claim 1, wherein the x-ray optic system comprises at least one capillary x-ray optic having an inner surface profile comprising at least one segment of a quadric shape.

8. The apparatus of claim 1, wherein an angle between the propagation direction of the focused x-ray beam and an optical axis of the objective is less than 30 degrees.

9. The apparatus of claim 1, wherein the microscope further comprises a mirror configured to receive and reflect the light from the portion of the sample propagating substantially collinearly with an x-ray propagation axis and to deflect at least some of the light away from the x-ray propagation axis.

10. The apparatus of claim 1, wherein the apparatus comprises a multi-modal illumination apparatus.

11. The apparatus of claim 1, wherein the microscope is a visible light microscope, an infrared light microscope, and/or a near-infrared light microscope.

12. The apparatus of claim 1, wherein the microscope is configured to be operated in a brightfield illumination mode and/or a darkfield illumination mode.

13. The apparatus of claim 1, wherein the objective comprises a reflective microscope objective.

14. The apparatus of claim 13, wherein the reflective microscope objective comprises a first aspherical mirror and a second aspherical mirror.

15. The apparatus of claim 1, wherein the objective comprises a refractive microscope objective.

16. The apparatus of claim 15, wherein the refractive microscope objective comprises at least one lens.

17. The apparatus of claim 1, wherein the objective comprises a hole, at least a portion of the x-ray optic system within the hole.

18. An apparatus comprising:
an x-ray optic system configured to receive x-rays from an x-ray source, to focus at least some of the x-rays to form a focused x-ray beam, and to irradiate a portion of a sample with the focused x-ray beam, the focused x-ray beam having a depth-of-focus and a focused x-ray spot at the sample; and
a microscope objective configured to receive and focus light from the portion of the sample, the objective having an optical axis and the x-ray optic system having an x-ray propagation axis tilted relative to the optical axis, the objective having an object plane and a field-of-view, the object plane within a range centered on the depth-of-focus of the focused x-ray beam, the range having a width ten times the depth-of-focus, and the focused x-ray spot within the field-of-view of the objective.

19. The apparatus of claim 18, wherein the x-ray optic system is located outside the objective.

20. The apparatus of claim 18, wherein at least a portion of the x-ray optic system is located within the objective.

21. The apparatus of claim 18, wherein the x-ray propagation axis and the optical axis have a non-zero angle therebetween.

22. The apparatus of claim 21, wherein the non-zero angle in a range of 5 degrees to 30 degrees.

23. The apparatus of claim 21, wherein the non-zero angle is in a range of less than 5 degrees.

24. An apparatus comprising:
at least one x-ray optic configured to receive x-rays from an x-ray source, to focus at least some of the x-rays to form a focused x-ray beam, and to irradiate a portion of a sample with the focused x-ray beam, the focused x-ray beam having a depth-of-focus and a focused x-ray spot at the sample; and
an objective configured to receive and focus light from the portion of the sample, the objective having an optical axis and the at least one x-ray optic having an x-ray propagation axis substantially parallel to and displaced from the optical axis, the objective having an object plane and a field-of-view, the object plane within a range centered on the depth-of-focus of the focused x-ray beam, the range having a width ten times the depth-of-focus, and the focused x-ray spot within the field-of-view of the objective.

25. The apparatus of claim 24, wherein the at least one x-ray optic is displaced from a center axis of the objective.
